(19) United States
(12) Patent Application Publication
(10) Pub. No.: US 2003/0103170 A1
(43) Pub. Date: Jun. 5, 2003

(54) Display apparatus

(75) Inventors: Akinori Nagata, Kikuchi-gun (JP); Satoshi Kotaka, Kikuchi-gun (JP)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(73) Assignee: ADVANCED DISPLAY INC., Kikuchi-gun (JP)

(21) Appl. No.: 10/307,476

(22) Filed: Dec. 2, 2002

(30) Foreign Application Priority Data
Dec. 5, 2001 (JP) 2001-371457

(51) Int. Cl. H04N 5/64

(52) U.S. Cl. 348/794

(57) ABSTRACT

A display apparatus is provided with a display module having a display surface and being provided with a first hole on the reverse side of the display surface, a housing being located in a position reverse to the display surface of the display module and being provided with a second hole formed in a position corresponding to the first hole, and a screw for being inserted into the second hole on the housing from the side reverse to the display module, to be fitted into the first hole, so as to fix the display module to the housing, thereby facilitating mounting of the display module on the housing and miniaturizing the housing.

### BACKGROUND OF THE INVENTION

1. Field of the Invention

The present invention relates to a display apparatus, and particularly to a technique effective in increase of a work efficiency in mounting a display module on a housing of a device such as an electronic device and in miniaturization of the housing.

2. Related Background Art

Generally, a display module such as a liquid crystal module is used in being mounted on a housing of an electronic device (a display unit). A conventional mounting method of a display module on a housing is disclosed in Japanese Patent Application Laid-Open No. 2001-83900, for example. FIG. 9 is an explanatory view to show mounting of a display module on a housing in the above conventional technique. In FIG. 9, reference numeral 1 designates a base frame (rear frame), 2 a reflective sheet, 3 a light guide plate, 7 an optical sheet, 8 a front frame, 9 a hole, 10 a screw, 22 a display unit, 23 a shell structure (housing), 24a a front shell, 24b a rear shell, 25 a liquid crystal display module, 26 a display window, 27 a metal mounting plate, 28 a liquid crystal panel, 29 a backlight, and 30 an insert fitting.

In the display unit 22 shown in FIG. 9, the liquid crystal display module 25 is contained within the shell structure 23. The shell structure 23 consists of the front shell 24a having the display window 26 and the rear shell 24b not having the display window 26. The liquid crystal display module 25 is provided with the hole 9 on the reverse side of a display surface thereof. The hole 9 is arranged in a position where it is overlapped with the liquid crystal panel 28. The screw 10 is fitted into the hole 9 through the rear shell 24b, thereby fixing the liquid crystal display module 25 to the shell structure 23.

However, the display unit of the above-described structure as employed in the conventional technique requires mounting of the liquid crystal display module 25 on the rear shell 24b and also on the front shell 24a having the display window 26. Therefore, mounting work has been complicated. Besides, it is hard in the above structure to narrow a picture frame of the display unit, which introduces the problem that miniaturization of the display unit has been difficult.

### SUMMARY OF THE INVENTION

The present invention has been accomplished to solve the above problems, and an object of the present invention is thus to provide a technique in a display apparatus which facilitates mounting of a display module on an electronic device and so on, and miniaturizes a housing which contains the display module.

A first display apparatus according to the present invention is a display apparatus having a display module having a display surface and being provided with a first hole on the reverse side of the display surface; a housing being located in a position reverse to the display surface of the display module and being provided with a second hole formed in a position corresponding to the first hole; and a screw for being inserted into the second hole on the housing from the side reverse to the display module, to be fitted into the first hole, so as to fix the display module to the housing.

A second display apparatus according to the present invention is the first display apparatus, wherein the housing has a substantially flat surfaces, at least one side of which being provided with a side wall formed perpendicular to the display surface.

A third display apparatus according to the present invention is the first display apparatus, wherein the housing further has a guide rail used for inserting the display module.

A fourth display apparatus according to the present invention is the third display apparatus, wherein the display module further has a guide rail or a groove which is able to fit with a guide rail of the housing.

A fifth display apparatus according to the present invention is the third or fourth display apparatus, wherein one end of the guide rail of the housing has a stopper to stop the display module.

A sixth display apparatus according to the present invention is a display apparatus having a display module having a display surface and being provided with a guide rail or a groove on a surface other than the display surface; and a housing being located in a position reverse to the display surface of the display module and having a guide rail which is able to fit with the guide rail or the groove of the display module.

A seventh display apparatus according to the present invention is the sixth display apparatus, wherein one end of the guide rail of the housing has a stopper to stop the display module.

A eighth display apparatus according to the present invention is the seventh display apparatus, wherein the other end of the guide rail of the housing has a fixing member to fix the display module after the guide rail or the groove of the display module has been inserted to the guide rail of the housing.

A ninth display apparatus according to the present invention is a display apparatus having a display module having a display surface; a housing having a window in a position corresponding to the display surface of the display module, and at least one surface of which being partially opened to take in the display module; and a covering member to cover the opening.

A tenth display apparatus according to the present invention is the ninth display apparatus, further having a first hole provided for the display module on the reverse side of the display surface thereof; a second hole provided for the housing on the reverse side of the surface having the window, in a position corresponding to the first hole; and a screw for being inserted into the second hole on the housing from the reverse side of a surface having the window, to be fitted into the first hole, so as to fix the display module to the housing.

The present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is an exploded view of a display module according to a first embodiment of the present invention.

FIG. 2 is an explanatory view to show mounting of a display module on a housing according to the first embodiment of the present invention.

FIG. 3 is a rear view of a housing with a display module being mounted thereon according to the first embodiment of the present invention.

FIG. 4 is an explanatory view to show mounting of a display module on a housing according to a second embodiment of the present invention.

FIG. 5A is a cross-sectional view along line B-B in FIG. 4 after the display module has been mounted on the housing.

FIG. 5B is another cross-sectional view along line B-B in FIG. 4 after the display module has been mounted on the housing.

FIG. 5C is another cross-sectional view along line B-B in FIG. 4 after the display module has been mounted on the housing.

FIG. 6 is an explanatory view to show mounting of a display module on a housing according to a third embodiment of the present invention.

FIG. 7 is a cross-sectional view along line C-C in FIG. 6 after the display module has been mounted on the housing.

FIG. 8 is an explanatory view to show mounting of a display module on a housing according to a fourth embodiment of the present invention.

FIG. 9 is a sectional view of a conventional display unit.

### DESCRIPTION OF THE PREFERRED EMBODIMENTS

A First Embodiment:

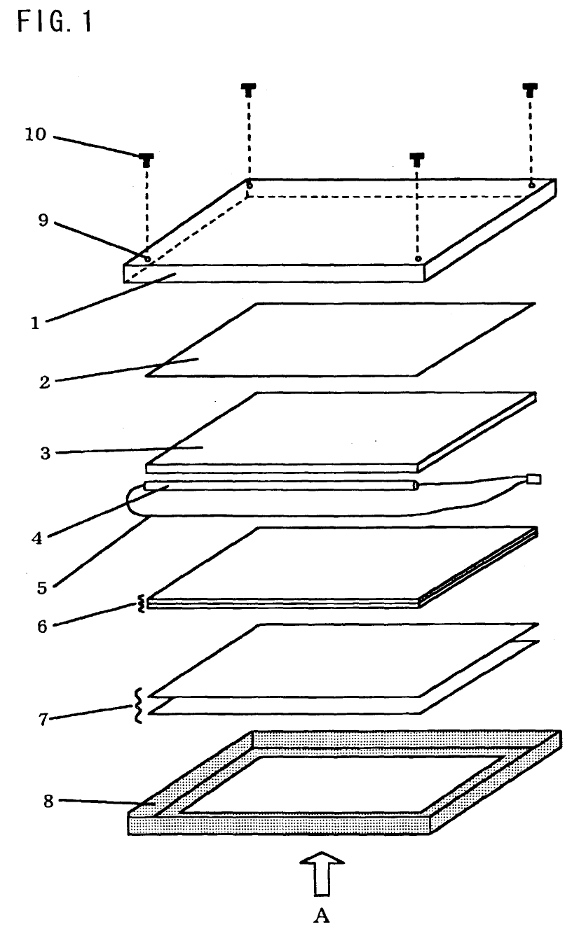

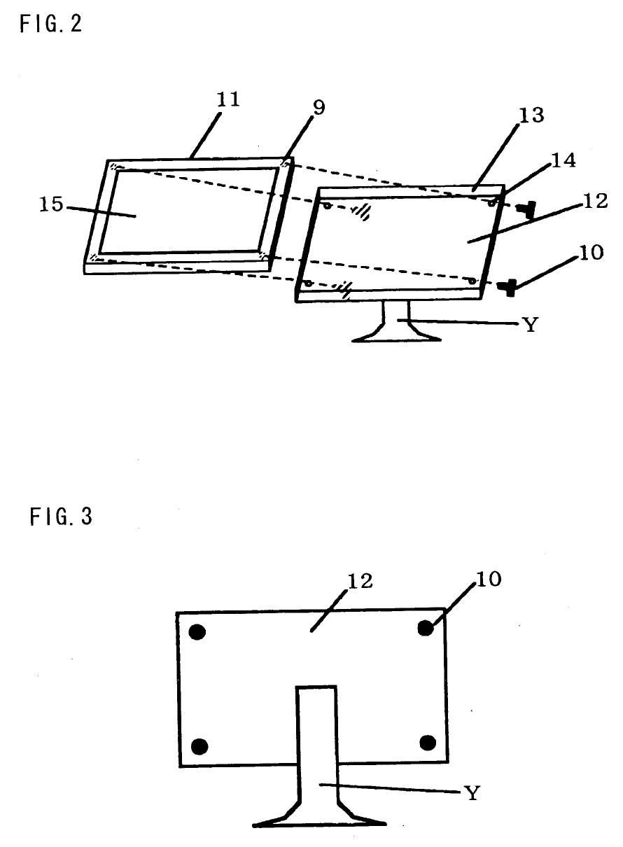

A first embodiment of the present invention will be described hereinafter with reference to FIGS. 1 to 3. FIG. 1 is an exploded view of a display module according to the first embodiment of the present invention. FIG. 2 is an explanatory view to show mounting of the display module on a housing. FIG. 3 is a rear view of the housing with the display module being mounted thereon. In FIGS. 1 to 3, reference numeral 1 designates a rear frame, 2 a reflective sheet, 3 a light guide plate, 4 a lamp, 5 a power line for the lamp, 6 a display panel, 7 an optical sheet, 8 a front frame, 9 a hole, 10 a screw, 11 a display module, 12 a housing, 13 a side wall provided on at least one side of the housing, 14 a hole provided on the housing, and 15 a display surface.

FIG. 1 is an exploded view of a display module using a display material such as liquid crystal. The display surface of the display module is the side to be faced when seeing the display module as shown in the upward arrow designated by reference symbol A at the bottom of FIG. 1. The hole 9 (a first hole) is provided on the backside of the rear frame 1. On the reverse side of the surface with the hole 9, the reflective sheet 2 is arranged. Then, the lamp 4 being a light source and the light guide 3 for conducting light of the lamp 4 uniformly to the display surface are arranged. Further, the display panel 6 and the optical sheet 7 are disposed. The display panel 6 has a display material such as liquid crystal being filled between two insulating substrates and is provided with a drive circuit (not shown) for driving the display material. The optical sheet 7 is a prism sheet and so on. Though FIG. 1 shows a case where two optical sheets are provided, the number of the sheet may be one or more than two in accordance with optical specifications. Finally, the front frame 8 is attached to the rear frame 1, thereby completing the display module.

FIG. 2 is a view to explain mounting of the display module shown in FIG. 1 on the housing. Here, the display module is mounted on the housing in order for use as an electronic device (a display unit) such as a monitor. Reference symbol Y in FIG. 2 designates a supporting member of the housing. As shown in FIG. 2, the reverse side of the display surface of the display module 11 is mounted on the housing 12. First, the reverse side of the display surface 15 of the display module 11 is faced to the housing 12. The housing 12 is provided with the hole 14 (a second hole) into which the screw 10 is inserted. The screw 10 is fitted into the hole 9 provided on the rear frame 1 of the display module 11. That is, the screw 10 is inserted into the hole 14 from the backside of the housing 12 to be fitted into the hole 9. The display module 11 is thus fixed to the housing 12. Here, the term “housing” in the present specification refers not only to those of box-shaped for containing the display module 11 and so on, but to anything for fixing or supporting the display module when assembling a display apparatus.

In the present embodiment, the surface of the housing 12 on which the display module 11 is mounted is substantially flat. Further, in a periphery of the mounting surface, there is provided the side wall 13 for supporting the display module 11. The side wall 13 projects substantially perpendicularly to the mounting surface. This configuration is capable to hold the display module during the mounting work of the display module 11. The side wall 13 works when provided on at least one side of the substantially flat surface of the housing 12, and it may be in four sides thereof. Or, the housing maybe without the side wall 13. In addition, it is preferable that a height of the projection of the side wall 13 is approximately the same as a thickness of the display module 11. The height of the side wall 13 may be less than the thickness of the display module 11 for good appearances. The side wall 13 should have the height capable of supporting the display module 11 while it is being fixed to the housing with the screw 10.

As in the foregoing, the front frame is exposed in this configuration. Therefore, a material which does not affect the appearances is desirable for the front frame 8 of the display module 11. Among such materials are plastic resins, magnesium alloys, stainless steels, and aluminum, for example.

FIG. 3 is a rear view of the display surface of the housing 12 after the display module 11 has been mounted on the housing 12. The screw 10 used for fixing is exposed on the backside of the housing 12. In order to improve the appearances, the screw may be covered with a covering member such as a seal, resin, and the like.

In this configuration, when mounting the display module 11 on the housing 12, it is only needed to fix the display module 11 to the housing 12. Therefore, it can avoid the need to attach another housing for covering the display surface (the front shell 24a shown in the conventional technique, for example). Consequently, the present invention increases a work efficiency and reduces the number of parts. Besides, it eliminates the need for a periphery of the display module which has been conventionally necessary for the mounting the housing for covering the display surface. Therefore, the present invention allows to narrow a picture frame of the housing, which attains its miniaturization.

A Second Embodiment:

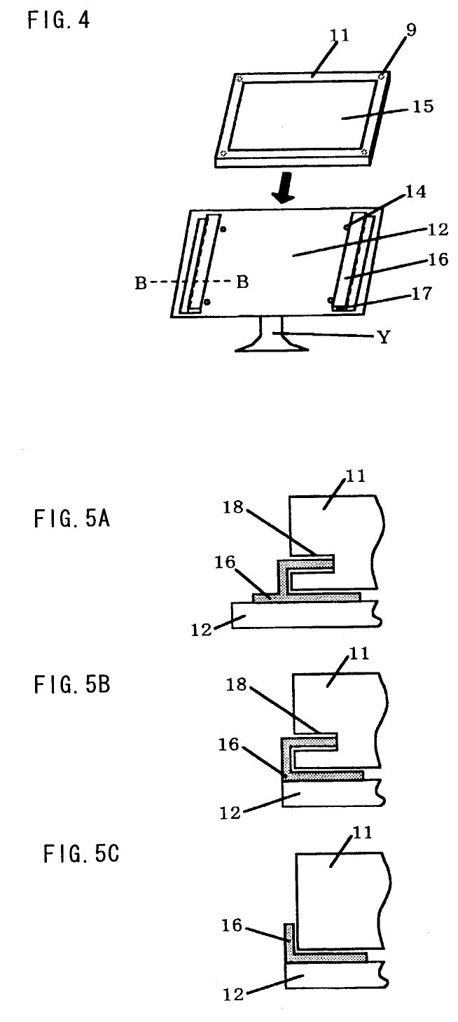

A second embodiment of the present invention will be described hereinafter with reference to FIGS. 4 and 5. FIG. 4 is a view to explain mounting of a display module on a housing. FIG. 5A is a cross-sectional view along line B-B in FIG. 4 after the display module has been mounted on the housing. FIG. 5B and FIG. 5C are cross-sectional views along line B-B in FIG. 4 after the display module has been mounted on the housing, showing different sectional configurations from that of FIG. 5A. In FIGS. 4 and 5, the same elements as in FIGS. 1 to 3 will be denoted by the same reference symbols. In the following, differences from the first embodiment will be described. In FIGS. 4 and 5, reference numeral 16 designates a guide rail of the housing, 17 a stopper, and 18 a groove of the display module.

According to the present embodiment as shown in FIG. 4, when mounting the display module on the housing, the display module 11 is inserted to the housing 12 as sliding on the guide rail 16 provided on the housing. After set to a mounting position, the display module 11 is fixed to the housing with a screw (not shown) being fitted into the hole 9 (the first hole) on the display module as is the case with the first embodiment. Here, the screw is inserted into the hole 14 (the second hole) on the housing from the reverse side of the surface on which the display module is mounted. It is preferable here to provide the stopper 17 for stopping the display module 11 at one end of the guide rail 16 as shown in FIG. 4. The stopper 17 is formed with a member identical to or different from that of the guide rail 16. Also, the stopper 17 is formed in such a position and shape that it can stop the display module 11. Further, it is desirable that a stop position of the hole 9 in the display module 11 determined by the stopper 17 approximately coincides with a position of the hole 14 in the housing. In addition, an insertion slot of the guide rail 16 in the display module 11 may be provided with a fixing member similar to the above stopper. In this configuration, after inserted to the housing 12, the display module 11 can be fixed in a prescribed position.

Moreover, as shown in FIG. 5A, it is possible to provide the housing with the guide rail 16, and the display module 11 with the groove 18 corresponding to the guide rail 16. The display module 11 can be thus slid to be fixed to the housing 12. FIG. 5B shows another configuration of the guide rail 16 and the groove 18. The guide rail 16 of the housing 12 may take a form of horseshoe at the edge of the housing 12 in order to allow further downsizing of the housing. FIG. 5C shows another configuration of the guide rail 16 and the groove 18. The guide rail of the housing 12 may take a form of L-shape at the edge of the housing 12 in order to have similar effects to the case of FIG. 5B. Besides, there is an advantage of eliminating the need to provide a groove in the display module 11.

In the configuration explained in the foregoing, it is possible in the present embodiment to improve workability, reduce the number of parts, and attain miniaturization as in the first embodiment. Further, the display module 11 may be slid to be mounted on the housing 12. It facilitates alignment of the hole 9 in the display module 11 with the hole 14 in the housing 12. Additionally, one end of the guide rail 16 may be provided with a fixing member for fixing the display module 11. The display module 11 can be thus fixed after having been inserted. Accordingly, the present embodiment has an advantage of avoiding the need for a screw.

A Third Embodiment:

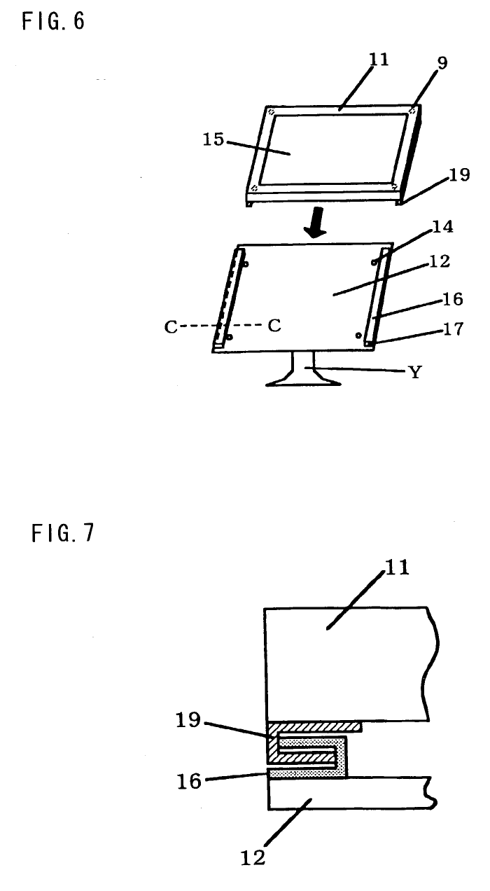

A third embodiment of the present invention will be described hereinafter with reference to FIGS. 6 and 7. FIG. 6 is a view to explain mounting of the display module on the housing according to the third embodiment. FIG. 7 is a cross-sectional view along line C-C in FIG. 6 after the display module has been mounted on the housing. In FIGS. 6 and 7, the same elements as in FIGS. 1 to 5 will be denoted by the same reference symbols. Differences from the second embodiment will be described hereinbelow. In FIG. 6 and 7, reference numeral 19 designates a guide rail of the housing. In the present embodiment, the display module 11 is provided with the guide rail 19, in addition to the configuration of the second embodiment. The guide rail 19 and the guide rail 16 are fitted to each other after the display module has been inserted. The display module 11 is then mounted on the housing 12 as sliding on these rails.

In this configuration, similar effects to the case of the second embodiment can be obtained. One end of the guide rail 16 of the housing 12 may be provided with the stopper 17 in the present embodiment as well. Also, the other end of the guide rail 16 may be provided with a fixing member capable of fixing the display module. It can eliminate the need for fixing by a screw. In the second and third embodiments explained above, the guide rail 16 is installed to the housing 12 on the side facing to the display module. The guide rail 16 may be, however, installed to the side face of the housing 12. Similarly, though the guide rail 19 is installed to the backside of the display module, it may be installed to the side face thereof.

The above-mentioned first to third embodiments explain a case where the housing 12 is approximately equivalent to or slightly bigger in size than the display module 11. Nevertheless, it is not restricted thereto, and the housing may be smaller than the display module as long as it has such a configuration that the display module is fixed to the housing. Also, there are installed four screws, each at four corners of the housing 12, in the first to third embodiments. The position and the number of screws are, however, not necessarily the same as shown in the figures. They may be different as long as they are sufficient to fix the display module 11 to the housing 12.

A Fourth Embodiment:

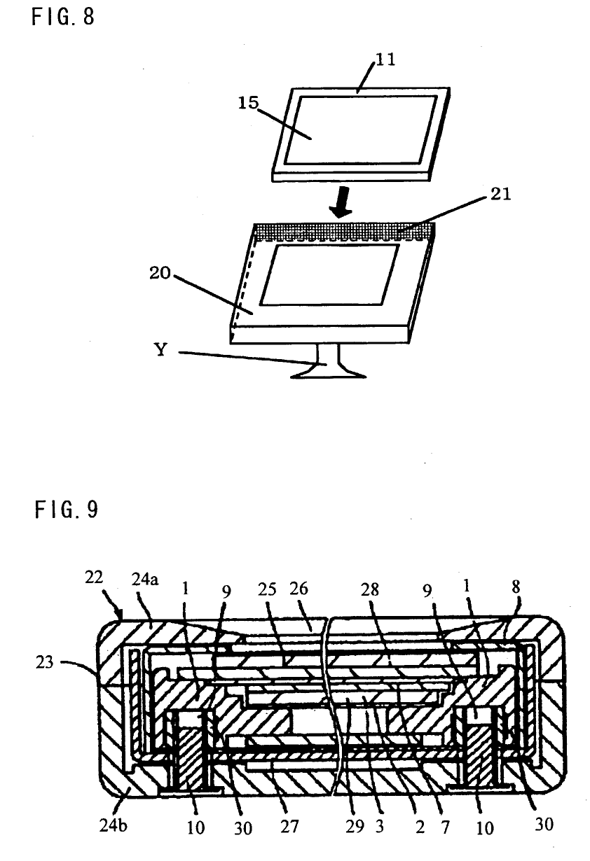

A fourth embodiment of the present invention will be described hereinafter with reference to FIG. 8. FIG. 8 is a view to explain mounting of the display module 11 on a housing 20 according to the fourth embodiment. In FIG. 8, the same elements as in FIGS. 1 to 7 will be denoted by the same reference symbols. Differences from the first to third embodiments will be explained in the following. In FIG. 8, reference numeral 20 designates a housing, and 21 an opening of the housing. In the present embodiment, there is provided the housing 20 having a window corresponding to the display surface 15 of the display panel 11 as shown in FIG. 8. At least one surface of the housing 20 is partially opened, so that the display module 11 is taken in from the opening 21.

It is possible to provide the housing 20 or the display module 11 with a guide rail as explained in the above second and third embodiments for use in taking the display module 11 into the housing 20. In addition, while not shown in FIG. 8, there may be provided a covering member for covering the opening 21 after the display module 11 has been taken into the housing 20. The covering member is preferably made of the same material as the housing 20. The display module 11 may be fixed to the housing 20 with the above-mentioned covering member. Or, the fixing may be with a screw installed from the backside of the housing 20 as in the embodiments explained above. When a screw is used for the fixing, the above-mentioned covering member may be eliminated for the better appearances and reduction of the number of parts.

In the configuration explained above, mounting of the display module on the housing can be completed with fixing the display module to the housing. Therefore, the need to attach another housing can be avoided. Consequently, increase of a work efficiency and reduction of the number of parts can be attained. Besides, it narrows a picture frame of the housing which is a periphery of the display module, thereby achieving miniaturization.

The display apparatus in accordance with the above-mentioned first to fourth embodiments are not limited to those using liquid crystal. The present invention is, as a matter of course, applicable to display apparatus with any display module for being mounted on a housing, which includes those using electroluminescence or field sequential liquid crystal. Also, while the above-mentioned first to fourth embodiments explains a case where the present invention is applied to display apparatus of desktop-type, the present invention is not restricted thereto. For example, the present invention may be applied to display apparatus of notebook-type or portable-type.

Though the first to fourth embodiments in accordance with the present invention are explained in the foregoing, it is understood that the present invention is not restricted to thereto, whereas they are susceptible of numerous changes and modifications as long as they do not deviate from the gist of the present invention.

As in the foregoing, the present invention makes it possible to increase a work efficiency in mounting a display module on a housing, and to reduce the number of parts. Moreover, the present invention narrows a picture frame of the housing which is a periphery of the display module, thereby attaining miniaturization.

What is claimed is:

1. A display apparatus comprising:
a display module having a display surface and being provided with a first hole on the reverse side of said display surface;
a housing being located in a position reverse to said display surface of said display module and being provided with a second hole formed in a position corresponding to said first hole; and
a screw for being inserted into said second hole on said housing from the side reverse to said display module, to be fitted into said first hole, so as to fix said display module to said housing.

2. A display apparatus according to claim 1, wherein said housing further comprises:
a substantially flat surface, and
a side wall being formed in at least one side of said surface and being substantially perpendicular to said display surface.

3. A display apparatus according to claim 1, wherein said housing further comprises a guide rail used for inserting said display module.

4. A display apparatus according to claim 3, wherein said display module further comprises a guide rail or a groove which is able to fit with said guide rail provided for said housing.

5. A display apparatus according to claim 3 or 4, wherein said guide rail of said housing further comprises, at one end thereof, a stopper to stop said display module.

6. A display apparatus comprising:
a display module having a display surface and being provided with a guide rail or a groove on a surface other than said display surface; and
a housing being located in a position reverse to said display surface of said display module and having a guide rail which is able to fit with said guide rail or said groove of said display module.

7. A display apparatus according to claim 6, wherein said housing further comprises, at one end of said guide rail thereof, a stopper to stop said display module.

8. A display apparatus according to claim 7, wherein said housing further comprises, at the other end of said guide rail thereof, a fixing member to fix said display module after said guide rail or said groove of said display module has been inserted to said guide rail of said housing.

9. A display apparatus comprising:
a display module having a display surface;
a housing having a window in a position corresponding to said display surface of said display module and being provided with an opening formed partially on at least one surface thereof so as to take in said display module; and
a covering member to cover said opening.

10. A display apparatus according to claim 9, further comprising:
a first hole provided for said display module on the reverse side of said display surface thereof;
a second hole provided for said housing on the reverse side of a surface having said window, in a position corresponding to said first hole; and
a screw for being inserted into said second hole on said housing from the reverse side of the surface having said window, to be fitted into said first hole, so as to fix said display module to said housing.
